(19) United States
(12) Patent Application Publication
(10) Pub. No.: US 2020/0028380 A1
(43) Pub. Date: Jan. 23, 2020

(54) ENERGY STORAGE BARGE

(71) Applicant: EnisEnerGen LLC., Henderson, NV (US)

(72) Inventors: Ben M. Enis, Henderson, NV (US); Paul Lieberman, Torrance, CA (US)

(21) Appl. No.: 16/042,140

(22) Filed: Jul. 23, 2018

(51) Int. Cl. H02J 15/00; H02S 10/40; C02F 1/22; F03D 9/17

(52) U.S. Cl. CPC H02J 15/006; H02S 10/40; H02J 3/383; F03D 9/17; C02F 1/22

(57) ABSTRACT

An Energy Storage Barge provides supplemental energy for a power system when renewable energy sources fail to provide enough hour at peak times. In an embodiment, the Energy Storage Barge is further provided a freeze chamber for pure water and mineral collection. In another embodiment, the Energy Storage barge produces super-chilled air to conduct freeze processing or maintain temperature of a cold storage facility.

### BACKGROUND OF THE INVENTION

The segment of the renewable power is growing fast, thereby, replacing traditional sources such as coal fired power plants. However, renewable power sources, such as solar and wind energy, are dependent upon environmental conditions. The power they provide the grid is subject to fluctuation. Furthermore, power consumption on the user end may fluctuate depending on the day, weather, time, etc.

Due to the intermittency of renewables and changing loads, baseload generating sources must be able to react quickly to keep the power grid stable by producing or absorbing additional power. It would be desirable to create a supplemental system to store the excess power produced by renewable energy sources when it is not needed by the end user. The addition of a floating power barge to a renewable energy system could create an efficient supplemental storage system if implemented correctly.

Floating power barge designs are charting new territory with projects on the boards with capacities up to 550 MW using technologies that include combined cycle with industrial and aero-derivative gas turbines and Integrated Gasification combined cycle (IGCC) schemes. Greater consideration is also being given to emissions and different fuels, particularly as the cost of oil increases to higher levels. Liquified Natural Gas (LNG), Compressed Natural Gas (CNG) and coal fueled projects are now being considered for installation on Floating Power Plants (FPPs).

A floating power plant provides a distinct advantage in that it is capable of moving from one location to another. This is achieved with the use of submersible heavy lift ships, designed to move very large structures around the world weighing upwards of 60,000 tons, or by a self-propulsion system. Furthermore, floating power plants which utilize compressed air energy storage systems (CAES) can be configured such that the steel pressure vessels of the system are immersed in water. Thus, as the compressed air is released from the steel walled pressure vessel, the residual air temperature in the pressure vessel tends lose temperature at a slower rate because of the heat drawn in across the steel/water interface into the residual air in the tank.

However, a floating power plant is limited, in that resources such as fuel may be difficult to transport to a floating power plant which is located offshore. Furthermore, the small footprint of the barge limits the size of the equipment and systems which can be utilized on the barge. Therefore, there is a need for a barge which utilizes a highly efficient energy storage system.

### SUMMARY OF THE INVENTION

In an embodiment, an offshore compressed air energy storage system is comprised of a barge. In an embodiment, the barge as a deck surface with one or more pressure vessels attached to the bottom of the deck surface. The one or more pressure vessels providing floatation for the barge and are in fluid communication with one another via a manifold

A power source is provided to the barge and is in communications with at least one air compressor provided on the deck surface of the barge. The air compressor is configured to pressurize the one or more pressure vessels.

In an embodiment, a compander is provided on the deck surface of the barge. The compander is comprised of at least one turboexpander, the at least one turbo expander has an input, an output, and a shaft. The compander also has at least one heat exchanger and at least one turbocompressor. In the embodiment, the compander is configured to exhaust super-chilled air.

In an embodiment, a mass air control valve is provided and configured to control the compressed air flow from the manifold of the one or more pressure vessels to the turboexpander. In a further embodiment, a natural-gas driven generator set (Gen-Set) provided on the deck surface of the barge. The Gen-Set receives the exhausted super-chilled air to improve efficiency of higher electricity output for the same amount of combusted natural gas.

The foregoing, and other features and advantages of the invention, will be apparent from the following, more particular description of the embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1A is a top view of the energy storage barge system, according to an embodiment of the present invention;

FIG. 1B is a side view of the energy storage barge system, according to an embodiment of the present invention;

FIG. 2 is a top view of the energy storage barge system, according to an embodiment of the present invention;

FIG. 3 is a top view of the energy storage barge system, according to an embodiment of the present invention;

FIG. 4 is a top view of the energy storage barge system, according to an embodiment of the present invention;

FIG. 5 is a top view of the energy storage barge system, according to an embodiment of the present invention;

FIG. 6 is a diagram representing the energy storage barge system, according to an embodiment of the present invention;

FIG. 7 is a graph depicting increased efficiency of a Gen-Set at low temperatures, according to an embodiment of the present invention;

FIG. 8 is a perspective view of a downdraft freeze chamber, according to an embodiment of the present invention;

FIG. 9 is a perspective view of an updraft freeze chamber, according to an embodiment of the present invention; and

FIG. 10 is a side view of the energy storage barge system, according to an embodiment of the present invention.

### DETAILED DESCRIPTION OF EMBODIMENTS

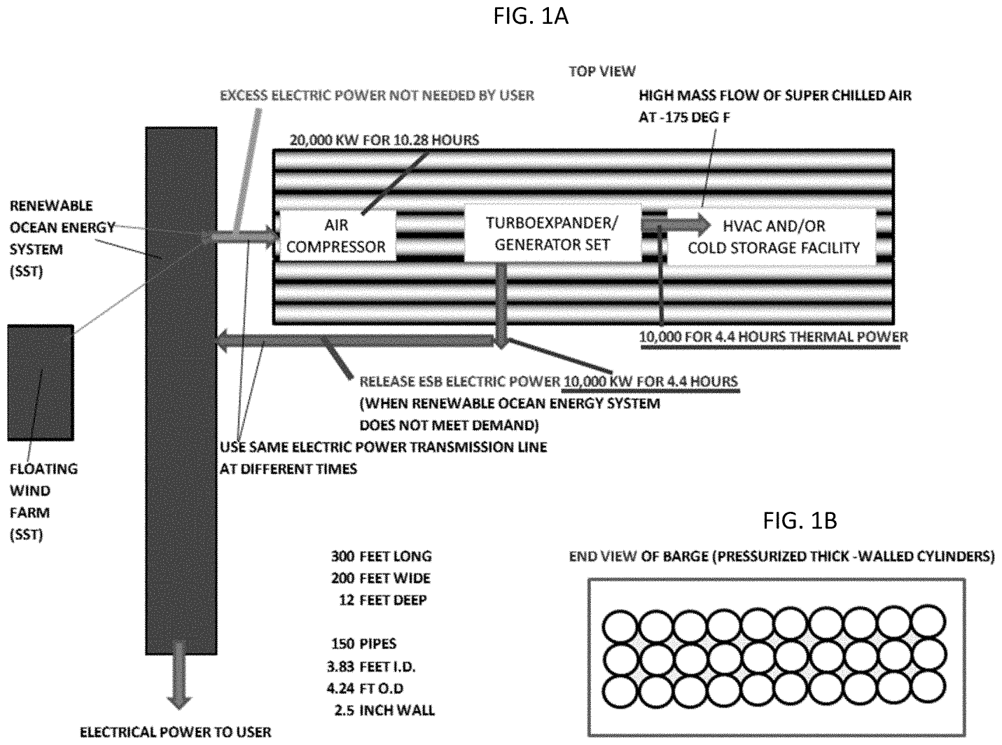

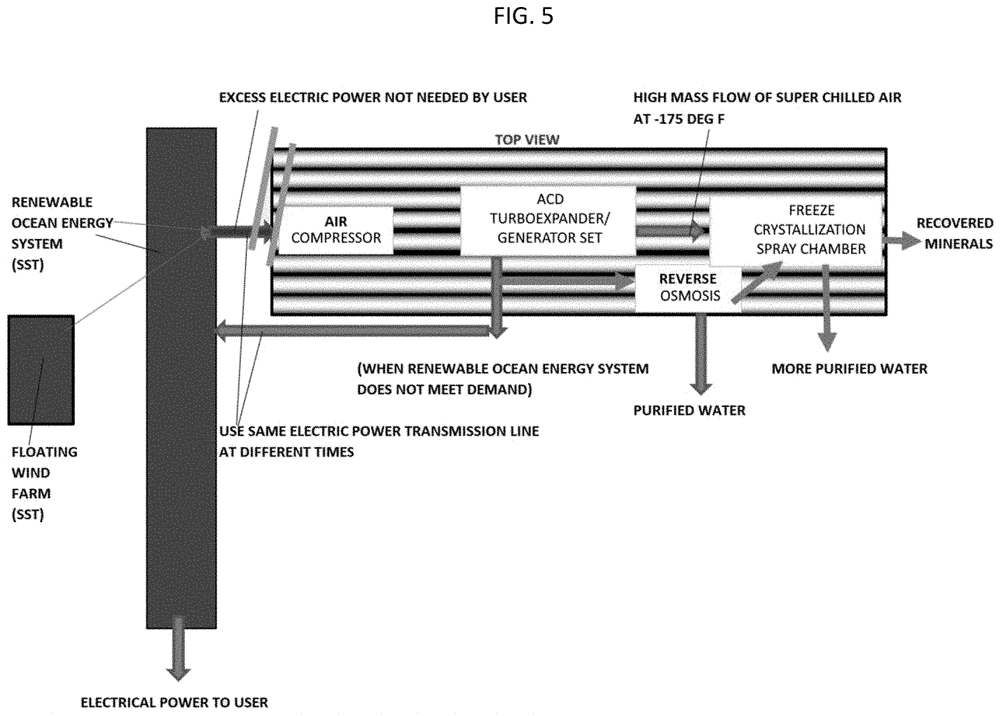

Embodiments of the present invention and their advantages may be understood by referring to FIGS. 1A-9, wherein like reference numerals refer to like elements.

With reference to FIGS. 1A-5, embodiments of an energy storage barge are depicted. In the embodiment, the energy storage barge is comprised of a plurality of pressure vessels, wherein at least some of the pressure vessels are in contact with the water which the barge is submerged in. In an embodiment, the energy storage barge is further comprised of a deck to hold the components of a compressed air energy storage system (CAES). In an embodiment, the plurality of pressure vessels are provided below the deck and keep the barge afloat, and the other components of the CAES system are provided on top of the deck.

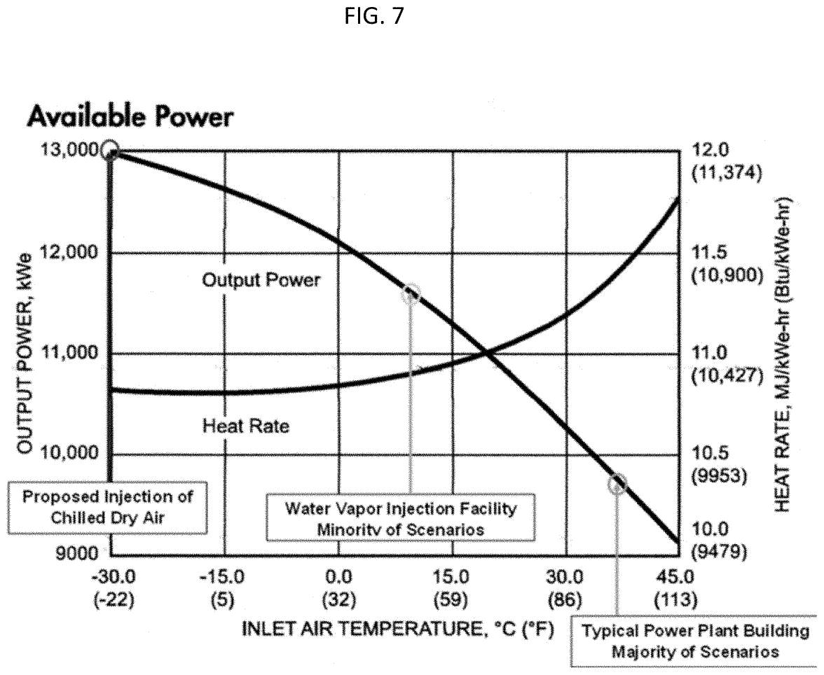

In an embodiment, the CAES system is comprised of at least an air compressor and turboexpander/generator set. In another embodiment, turbocompressor and turboexpander are used as a compander. The compander is provided to generate a high mass flow of super-chilled air. In an embodiment, the super-chilled air flowing from the two-stage, free-spooling compander is approximately −175° F. The super-chilled are can be used for multiple purposes. In one embodiment, the super-chilled air is fed to a Gen-Set. By providing the intake of the Gen-Set with super-chilled air, the efficiency of the Gen-Set is greatly increased (as depicted in FIG. 7). In another embodiment, the super-chilled air is exhausted to a freeze chamber, where contaminated water can be processed to recover pure water and minerals. In yet another embodiment, the super-chilled air is provided to a freeze processing factory or cold storage facility.

The CAES system is further provided with an air mass control valve to releases the pressure in the pressure vessels and feed a steady high mass of near room temperature air and intermediate pressure to the input of the turboexpander or compander.

In the embodiment, the CAES system is provided with a power source, preferably a renewable energy source. Example renewable energy sources might include photovoltaic arrays, on shore wind farms, offshore or floating wind farms, wave energy capture systems, Ocean Thermal Energy Conversion (OTEC) or tidal energy capture systems. In an embodiment, wind turbines or photovoltaic arrays could be placed on the barge to provide or supplement the power to CAES system of the barge.

In an embodiment, one transmission line is used to transfer power between the barge and the power sources. When the power sources are generating excess power, power is transmitted to the energy storage barge. When additional power is required to supplement the power sources, the power is transmitted from the storage barge to the power sources to then be transmitted to an end user.

In an example embodiment, the energy storage barge is approximately 300 feet long, 200 feet wide and 12 feet deep. In an example embodiment, the barge is comprised 120 cylindrical pressure vessels which have an inner diameter of approximately 3.83 feet and a wall thickness of 2.5 inches. In an embodiment, the pressure vessels are comprised of steel. The steel may be comprised of an alloy to prevent corrosion or may be coated to prevent corrosion. In another embodiment, the pressure vessels may be comprised of reinforced concrete. In an embodiment, the reinforced concrete pressure vessels comprise internal thin wall metal steel liner and network of metal reinforcement bars provide heat transfer with the water the barge resides in.

With specific reference to FIG. 1A, an embodiment of the energy storage barge (ESB) is depicted. In the embodiment, the ESB is provided with an air compressor and a turboexpander and generator set. When there is an excess in power from the power sources, power is feed to the air compressor of the ESB, which fills the pressure vessels of the barge. When additional power is needed to supplement the power sources, the mass air control valve opens to send stored compressed air to the turboexpander and generator set. The turboexpander and generator then produce electricity to supplement the power systems and to an end user. Simultaneously, the turboexpander produces a high mass flow of super chilled air (˜−175° F.) to an HVAC system or cold storage (refrigerated) facility.

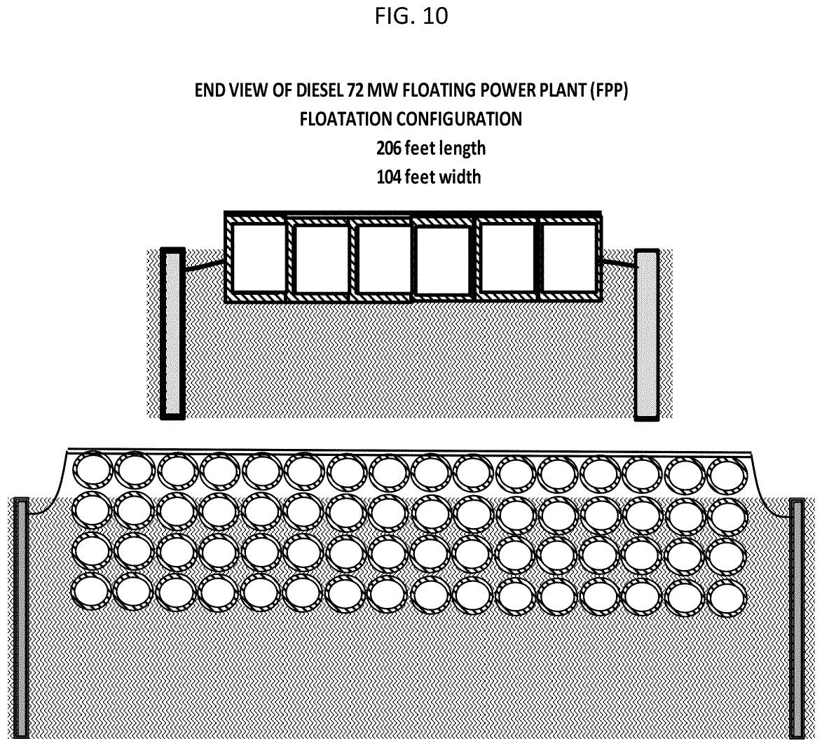

With reference to FIG. 1B, an end view depicting an example arrangement of the pressure vessels is shown. FIG. 10 shows a further depiction of the example arrangements of the pressure vessels. The energy storage barge can be provided in as a transportable barge or a stationary barge.

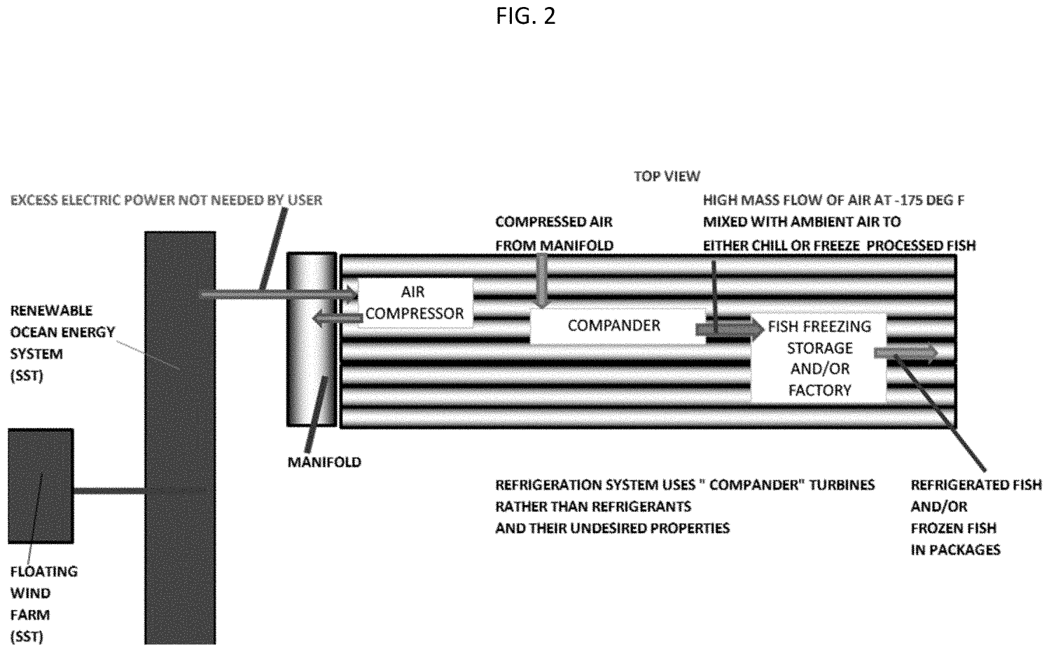

With reference to FIG. 2, an example embodiment of the ESB is shown wherein compressed air from the pressure vessels is fed into a compander. The compander supplies a high mass flow of super chilled air to a fish freezing or frozen fish storage facility. The availability of a fish freezing facility and/or storage center on a barge would provide quick accessibility for fishing boats that do not have onboard fish freezing systems.

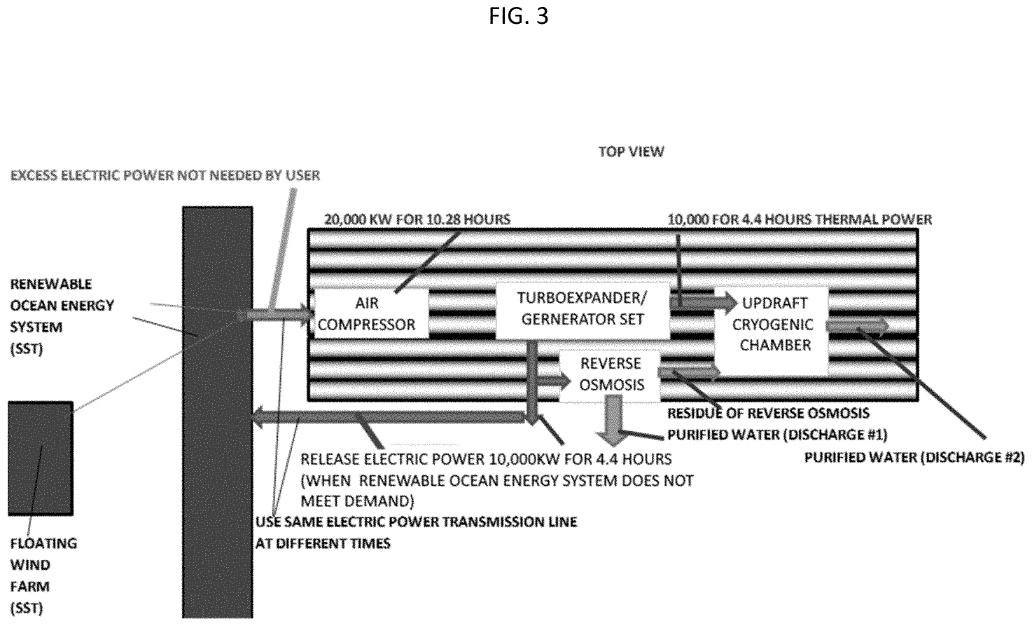

With reference to FIG. 3-5, example embodiments of the ESB are shown wherein the barge is further provided with a freeze crystallization chamber. In the embodiment, super chilled air from a compander is provided to the freeze crystallization chamber such that the freeze chamber can provide mineral separation or desalination of an incoming salt water or contaminated water supply. In an embodiment, the freeze crystallization chamber is configured to provide a eutectic separation of pure water from the minerals (including salt) in the water supply. The freeze crystallization chamber will recover pure water and minerals, both of which can be of value. Furthermore, the outgoing air from the freeze chamber will be cold (˜−22° F.), and in embodiment the cold air will be available to supply a Gen-Set, HVAC or refrigeration system.

In an embodiment, the ESB is further provided with a reverse osmosis system. In an embodiment, the reverse osmosis system may supplement the pure water provided by the freeze chamber when large amounts of pure water are needed to supply a crew or a processing system (such as fish freezing). In an embodiment, the reverse osmosis system supplies fresh water and output of a smaller quantity of unwanted concentrated solution. This unwanted concentrated solution will be supplied to the freeze crystallization chamber to undergo further purification.

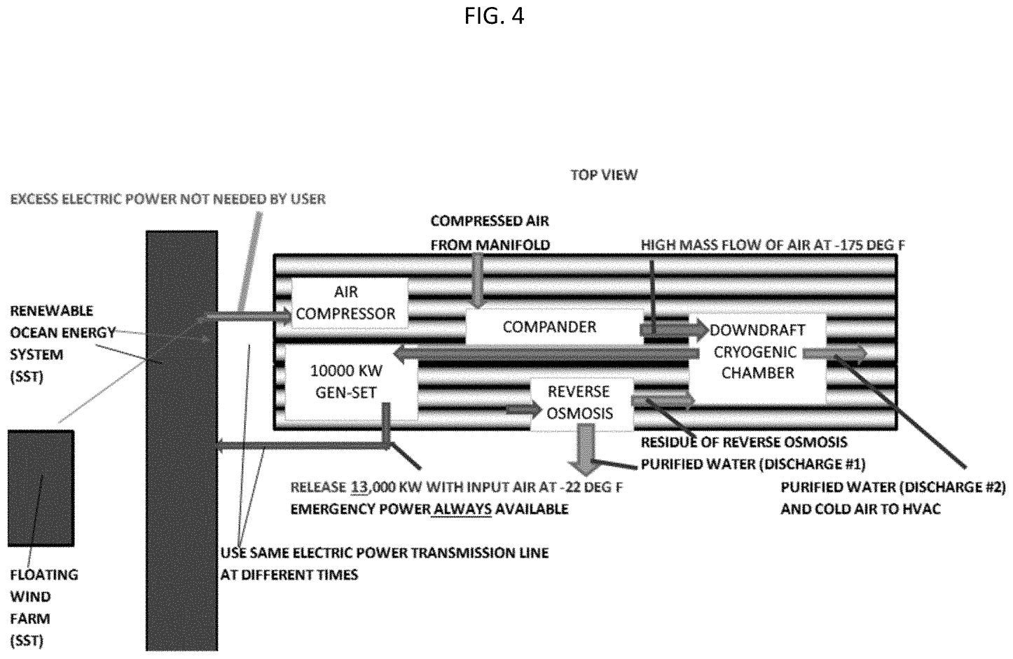

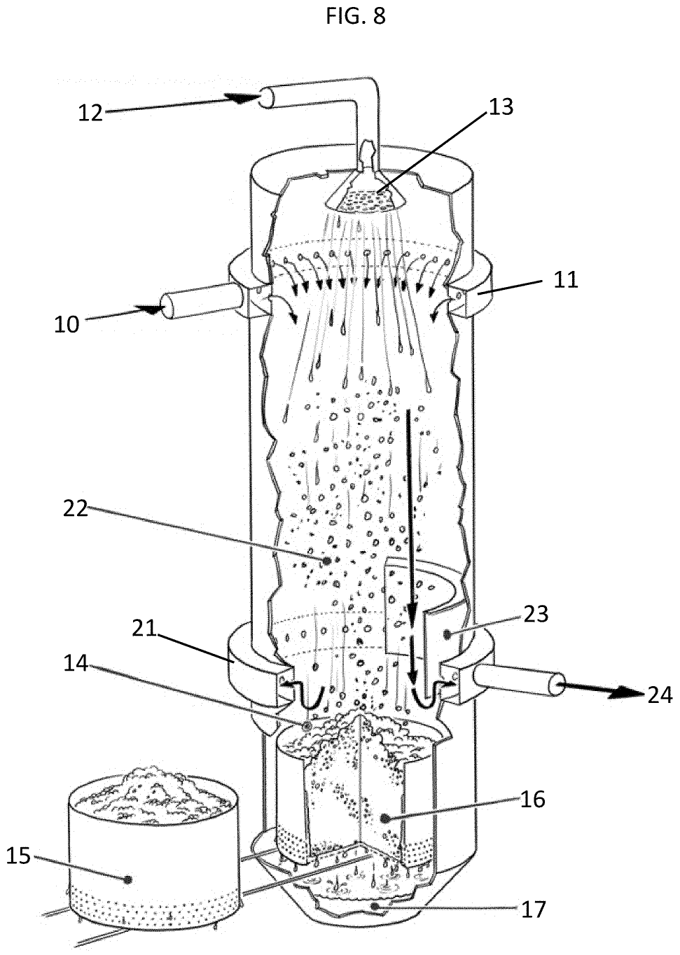

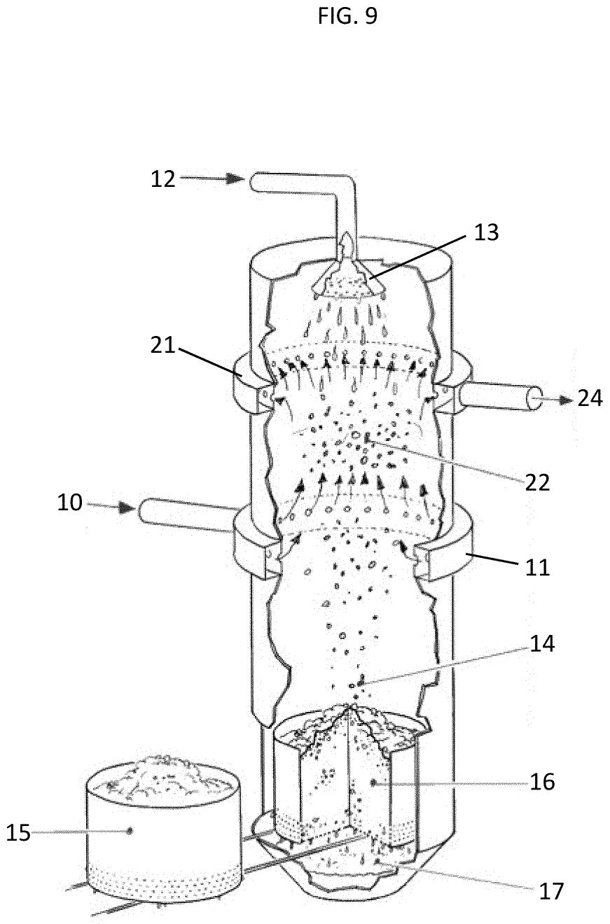

In an embodiment, the ESB will be provided with an updraft cryogenic chamber (depicted in FIG. 3). Further details of the updraft chamber can be found with reference to FIG. 9. The updraft chamber configuration provides a smaller footprint where space is limited on the barge. In another embodiment, the ESB will be provided with a downdraft cryogenic chamber (depicted in FIG. 4). Further details of the updraft chamber can be found with reference to FIG. 8.

In an embodiment, the air compressor system used on the barge operate can operate for approximately 10 hours on 20,000 KW. In the embodiment, the CAES system will produce about 10,000 KW over 4.4 hours to carry out the functions of the cryogenic freeze chamber, and simultaneously release about 10,000 KW over the same 4.4 hours to supplement the renewable energy systems.

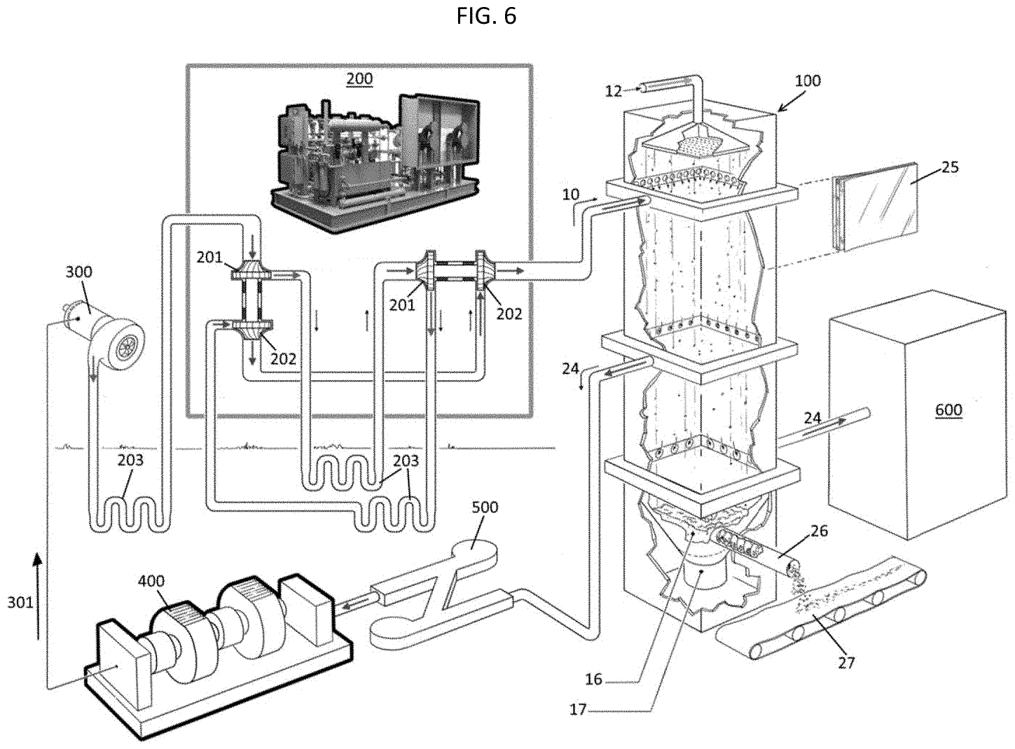

In reference to FIG. 6, a schematic of the freeze crystallization spray chamber is depicted, according to an embodiment of the present invention. In an embodiment, the spray chamber receives exhaust air at air inlet 10. In an embodiment, the air enters air inlet 10 as super-chilled air with a temperature of approximately −175° F. and mass flow rate of 140,000 pounds per hour (lbs/hr).

According to an embodiment, the air inlet 10 feeds the chilled air into intake duct 11. The intake duct then feeds the air into the top of the chamber. In an embodiment, intake duct 11 is provided about the perimeter of the chamber to emit the cold air evenly through the cross-section of the chamber. In an embodiment, the spray chamber receives wastewater at liquid inlet 12. In an embodiment, the wastewater is filtered before entering the liquid inlet to prevent clogging of the spray nozzle 13. In an embodiment, spray nozzle 13 is insulated to prevent ice formation within the nozzle. In an embodiment, the spray nozzle emits wastewater at a mass flow rate of approximately 3,060 gallons per hour. In an embodiment, the top of the chamber exhibits a dead space 14, wherein no flow of chilled air is present. The dead space prevents the spray nozzle 13 from experiencing temperatures which may cause ice formation, and therefore clogging within the nozzle.

Further referencing FIG. 6, in an embodiment, a perforated bucket is provided to collect the frozen ice fragments, which accumulate in an ice mass 16. The perforations of the bucket allow for concentrated brine water 17 to drain through the accumulation of porous ice fragments and be collected at the bottom of the chamber. In an embodiment, the ice bucket is removeable through a door to allow for the batch removal of ice from the chamber. In another embodiment, the ice is continuously removed by a rotating screw propulsion system 26 that feeds a conveyor belt.

In an embodiment, a spray chamber 100 is shown receiving chilled air from a two-stage, free-spooling compander system 200. In an embodiment, the air received from the compander system is approximately −175° F. In the embodiment, the free spooling compander receives air from compressor 300. The air is then sent through an underwater heat exchanger 203 before being received by the first stage compressor 201 and expander 202. The air is then feed through heat exchangers 203 before being processed by the second stage compressor 201 and expander 202 system, after which it is exhausted to the air inlet 10 of the spray chamber 100.

The spray chamber 100 may be provided with an updraft or downdraft configuration. In an embodiment, the spray chamber is provided with a rectangular configuration with a square cross section. In an embodiment, the chamber is constructed of panels formed by foam sandwiched between two steel sheets 25. The spray chamber is further provided with an array of square spray nozzles at the top of the chamber which receives filtered waste water from the liquid inlet 12. The spray chamber, as depicted, features two exhaust ducts which provide air outlets 24 to a centrifuge system 500 and a cold air storage system 600. The bottom of the chamber collects ice flakes in a porous mass 16 and concentrated waste or brine water 17. In the embodiment, a helical screw 26 is provided to remove the ice flakes from the chamber and onto a conveyor system 27.

In an embodiment, one of the air outlets 24 provides chilled air to a centrifuge system 500. The centrifuge system removes ice particles, which may damage the turbines of the Gen-Set system 400. The Gen-Set system receives the chilled air, with damaging particles removed, from the centrifuge 500. The chilled air improves the efficiency of the Gen-Set system, and the Gen-Set provides electricity to power the compressor 300.

FIG. 7 shows a graph of the Caterpillar Corporation, Solar Turbine Divisions Turbo Gen-Set MARS 100 performance as a function of intake air temperature. Providing a chilled air supply is known to greatly increase the efficiency of said Gen-Set. The input air temperature from +100° F. to −22° F. to provide a 30% increase in power for the same natural gas consumption. Turbo-driven Gen-Sets are often equipped with evaporative water spray inlet air cooling to bring the ambient air intake temperature of 100° F. down to 44° F. Thus, for the Solar Turbine's MARS 100 Gen-Set, by further dropping the temperature the 9,600 kWe electric power output is enhanced to almost 12,000 kWe.

With reference to FIG. 8, and embodiment of the spray chamber is a downdraft type. In an embodiment, the chamber is constructed of panels formed by foam sandwiched between two steel sheets. The spray chamber is further provided with a spray nozzle at the top of the chamber which receives filtered waste or salt water from the liquid inlet 12. The spray chamber, as depicted, features an exhaust duct 21 with provided air outlets 24 to a centrifuge system and/or a cold air storage system. The bottom of the chamber collects ice flakes in a porous mass 16 and concentrated waste or brine water 17. In an embodiment, a perforated bucket 15 is provided to collect the frozen ice fragments, which accumulate in an ice mass 16. The perforations of the bucket allow for concentrated brine water 17 to drain through and be collected at the bottom of the chamber. In an embodiment, the ice bucket 15 is removeable through a door to allow for the batch removal of ice from the chamber.

In a further embodiment, fresh water nozzles (not shown) are provided to spray the ice mass 16 to provide further washing of the ice mass. In an embodiment, intake duct 11 is configured to reintroduce the chilled air to combine with the air of the exit duct 19 before being exhausted from the chamber system. In an embodiment, the air in the exit duct 19 is at a temperature of approximately −6° F. before mixing with the chilled air of the intake duct prior to exiting the chamber system. In an embodiment, the air is exhausted at approximately −22° F. after mixing with the chilled air of the intake duct. In an embodiment, the air is exhausted to a Gen-Set, HVAC or cold air storage.

In reference to FIG. 9 an embodiment of a spray chamber is shown having an updraft configuration. In an embodiment, the spray chamber receives exhaust air at air inlet 10. In an embodiment, the air enters air inlet 10 as super-chilled air with a temperature of approximately −175° F. and mass flow rate of 140,000 pounds per hour (lbs/hr).

According to an embodiment, with further reference to FIG. 9, the air inlet 10 feeds the chilled air into intake duct 11 which then feeds the air into the chamber. In an embodiment, intake duct 11 is provided about the perimeter of the chamber to emit the cold air evenly through the cross-section of the chamber.

According to an embodiment, with further reference to FIG. 9, the spray chamber receives wastewater at liquid inlet 12. In an embodiment, the wastewater is filtered before entering the liquid inlet to prevent clogging of the spray nozzle 13. In an embodiment, spray nozzle 13 is insulated to prevent ice formation within the nozzle. In an embodiment, the spray nozzle emits wastewater at a mass flow rate of approximately 3060 gallons per hour. In an embodiment, the top of the chamber exhibits a dead space 14, wherein no flow of chilled air is present. The dead space prevents the spray nozzle 13 from experiencing temperatures which may cause ice formation, and therefore clogging within the nozzle.

Further referencing FIG. 9, in an embodiment, a perforated bucket 15 is provided to collect the frozen ice fragments, which accumulate in an ice mass 16. The perforations of the bucket allow for concentrated brine water 17 to drain through and be collected at the bottom of the chamber. In an embodiment, the ice bucket 15 is removeable through a door to allow for the batch removal of ice from the chamber.

In reference to FIG. 9, according to an embodiment, the chamber is provided with an exhaust duct 21. In an embodiment, the exhaust duct 21 is positioned above the intake duct 11. The configuration provides an updraft for the creation of ice fragments 22 at a position between the intake duct 11 and exhaust duct 21. The exhaust duct is provided about the perimeter of the chamber to evenly exhaust the chilled air from the chamber. In an embodiment, the air is exhausted at air outlet 24 with at approximately −25° F. after mixing with the chilled air of the intake duct. In an embodiment, the air is exhausted to an HVAC, cold air storage, or centrifuge leading to a Gen-Set system. A dead air zone 14 is created below the intake duct 11.

The small ice particles that are carried out of the chamber along the streamlines of the cold exit air are those ice particles that formed a brittle ice shell that explosively broke as the ice shell grew thickened and increased its internal tension as it pressed around an incompressible liquid droplet of waste material. These radially outward thrown ice particles are expected to be particularly clean of the undesired waste water materials. When this ice particle laden air is used to feed HVAC, the air is warmed so that the ice particles can be collected during the thaw. If the scale of the chamber is sufficiently large, this flow of accumulated thawed ice particles will generate pure water that can be collected for use as potable water.

In said counter flow heat exchange process the warm droplets of waste water will mix with the airflow so that the final mixture is at near the cold eutectic temperature of the wastewater. The droplets will initiate their freezing as the air exits near the top of the chamber. Near the middle height of the chamber, the −175° F. air is introduced into the chamber via an annulus duct around the chamber. At this height the droplet is designed to have attained its eutectic temperature and initiated an ice shell formation to achieve rapid separation of pure water from minerals or contaminates.

For a specific example embodiment of an operation CAES system on an ESB, the steps required to size the integrated CAES and FPP system are:
a. Define the electric power requirement of the Gen-Set (say, 11,350 kWe)
b. Define the electrical power requirement (say, 2,000 kWe)
c. Define the number of hours of the electrical power discharge (say, 8 hours)
d. Calculate the pressure vessel volume required
e. Define the length of the pressure vessel or length of barge (say, 200 feet lengths)
f. Define the inside diameter of the pressure vessel (pipe) (say, 4 feet)
g. Calculate the outside diameter of the pressure vessel
h. Define the space between horizontal pressure vessels (say, 0.5 feet)
i. Define the space between vertical pressure vessels (say, 0 feet)
j. Define the width of the array of pressurized pipes or width of barge (110 feet)
k. Calculate the layers of pipes below the barge deck
l. Calculate the weight of the pressurized pipes
m. Calculate the buoyancy force
n. Calculate the inflow air mass
o. Calculate the size of the compressor

In the embodiment, an example Gen-Set Power and Airflow Intake includes the Caterpillar Company, Solar Turbines, MARS 100 Gen-Set having 11,350 kWe, 73,727 SCFM intake air. The turbo expander requires 2,000 kW, 2,681 HP, 11.9 SCFM/HP (15% thermodynamic efficiency), 31,903 SCFM required. Turboexpander Power Discharge Time: 8 hours, 480 minutes, 15,313,673 SCF required.

Calculate the required Pressure Volume: 4 ft diameter, 18,000 feet length. cylinder, 226,195 CU FT water volume, 18,728,826 KT at 1,214.67 psia (start of operation), 3,309,967 SCF at 214.67 psia (end of operation), 15,418,860 SCF available air volume to drive turboexpander

Define the length of each Pipe Cylinder based on Barge Length: 200 feet lengths or 62 meters length, 90 cylinders required for 18,000 total pipe lengths.

Calculate the wall thickness required of the Pipe Cylinder: 40,000 psi stainless steel 316 tensile yield strength, 1,200 psig internal pressure, 48 inches internal diameter, 0.72 inches wall thickness required for safety factor=1.0, 1.44 inches wall thickness required for safety factor=2.0. The pressure vessel will be under water and there will be no nearby personnel so that a safety factor=2.0 is recommended.

Calculate the outside diameter required of the Pipe Cylinder: 50.88 inches outside diameter, 4.24 feet outside diameter, 0.5 ft spacing between cylinders.

Calculate the number of cylinders in a layer: 23 cylinders per layer, 109 feet width (or 33.2 meters wide).

Calculate the number of layers: 90 cylinders required for 18,000 total pipe length, 2.3 cylinders per layer thus 4 layers.

Calculate the weight of the cylinders (excluding the weight of end domes and manifold): 495 pounds per cubic feet of steel, 48 inches internal diameter, 1.44 inches wall thickness, 18,000 feet total pipe length, 14,098,261 pounds of all pipes, 7,049 tons as downward weight force when not underwater.

Calculate the buoyancy force: 64 pounds per cubic feet of salt water displaced, 50.88 inches outside diameter, 18,000 feet total pipe length, 8,133 tons of upward buoyancy force.

Calculate the inflow rate of ambient air using Gen-Set air intake requirement: 11,350 kWe Gen-Set, 91.8 pounds of air intake per second, 0.075 pounds/cu ft at STP, 73,440 SCFM, 100 deg F. input air temperature, −22 deg F. output air temperature, 39,028 SCFM ambient air, −170 deg F. input turboexpander exhaust air, −22. deg F. output air temperature, 31,903 SCFM turboexpander air, 70,931 SCFM total air flow from eductor to Gen-Set (almost matched to 73,440, repeat calculation until matched.

Calculate the compressor size: 2,750 kW, 3,686 HIP, 2.2 SCFM-IHP, 8,110 SCFM required.

| Air Pressure | Thermodynamic | Thermodynamic |
|---|---|---|
| (psia) | Efficiency (%) | Efficiency (SCF/HP) |
| 205 | 75 | 3.75 |
| 394 | 75 | 3.0 |
| 726 | 70 | 2.50 |
| 1,253 | 63 | 2.14 |

Use 2.2 SCFM/HP in this calculation to assure a conservative selection for the air compressor. This value is conservative because the operational cycle consists of compressing the pressure vessel from 214.67 psia to 1,214.67 psia in each cycle.
16 hours
960 minutes
7,785,523 SCF required
4 feet inside diameter
9,100 feet length cylinder
114,354 CU FT water volume
9,468,462 SCF at 1,214.67 psia
1,673,372 SCF at 214.67 psia.
7,795,090 SCF available (matched)

The above set of calculations can be used for sizing other combinations of compressor, pressure vessels, turboexpander/generator set, educator and turbocompressor driven Gen-Set.

The term barge has been used herein to describe any vessel, rig, platform, ship, tanker, etc. which can be used to describe a floating vessel which is partially submerged, or in some cases may be fully submerged, into a body of water.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

We claim:

1. An offshore compressed air energy storage system comprising:
a. a barge, the barge having a deck surface, and one or more pressure vessels attached to the bottom of the deck surface, the one or more pressure vessels providing floatation for the barge, the pressure vessels being in fluid communication with one another via a manifold;
b. a power source;
c. at least one air compressor provided on the deck surface of the barge, the power source being configured to power the at least one air compressor, the at least one air compressor is configured to pressurize the one or more pressure vessels; and
d. a compander provided on the deck surface of the barge, the compander having at least one turboexpander, at least one turbo expander having an input, an output, and a shaft, the compander further having at least one heat exchanger, and the compander having at least one turbocompressor, wherein the compander exhausts a high mass flow of super-chilled air;
e. a mass air control valve configured to control compressed air flow from the manifold of the one or more pressure vessels to the turboexpander; and
f. a turboexpander and generator set provided on the deck surface of the barge, wherein the turboexpander and generator set receives the high mass flow of super-chilled air from the compander.

2. The system of claim 1, wherein the power source is provided on the deck surface of the barge.

3. The system of claim 2, wherein the power source is one or more wind turbines.

4. The system of claim 2, wherein the power source is one or more photovoltaic cells.

5. The system of claim 2, wherein the power source is wave energy capture systems

6. The system of claim 2, wherein the power source is Ocean Thermal Energy Conversion (OTEC).

7. The system of claim 2, wherein the power source is tidal energy capture system

8. The system of claim 2, wherein the system is transportable.

9. The system of claim 1, further comprising a desalination facility comprising a desalination chamber, a salt water sprayer, a hopper, and a centrifuge in communication with the desalination chamber and the hopper, wherein the superchilled air exhausted by the compander freezes sprayed water within the desalination chamber, wherein the frozen water is collected in the hopper, and wherein the desalination facility is provided on the deck surface of the barge.

10. The system of claim 8, wherein the power source is provided on the deck surface of the barge.

11. The system of claim 9, wherein the power source is one or more wind turbines.

12. The system of claim 9, wherein the power source is one or more photovoltaic cells.

13. The system of claim 9, wherein the power source is wave energy capture systems

14. The system of claim 9, wherein the power source is Ocean Thermal Energy Conversion (OTEC).

15. The system of claim 9, wherein the power source is tidal energy capture system

16. The system of claim 9, wherein the system is transportable.
